(19) United States
(12) Patent Application Publication
(10) Pub. No.: US 2019/0359090 A1
(43) Pub. Date: Nov. 28, 2019

(54) LATCHING DEVICE FOR AUTOMOTIVE APPLICATIONS

(71) Applicant: Kiekert AG, Heiligenhaus (DE)

(72) Inventors: Keith Robertson, Livonia, MI (US); Jim Zhuang, Canton, MI (US); Philip Morrison, Monroe, MI (US)

(21) Appl. No.: 15/985,915

(22) Filed: May 22, 2018

(51) Int. Cl. B60N 2/225; B60N 2/22

(52) U.S. Cl. CPC B60N 2/2258; E05B 85/26; B60N 2/2245

(57) ABSTRACT

The object of the invention is a latching device (1) for a backrest of a motor vehicle, with a locking mechanism (4) fundamentally comprising a catch (5) and at least one pawl, whereby the catch (5) is pivotable and is accommodated in the latching device (1) to accommodate a latch holder (6) and whereby the locking mechanism (4) can be transferred at least into a main ratchet position, and preferably into a pre-ratchet position and a main ratchet position, by means of the latch holder (6), a latch housing (10), whereby the latch housing (10) has at least an integrated recess (13, 14, 15) and whereby the recess (13, 14,15) is formed as a damping means (11) for the latch holder (6) in the main ratchet position and whereby the integrated damping means (11) has a cooperating section (17), whereby the cooperating section (17) has a supportive effect on the damping means (11).

The invention relates to a latching device for automotive applications, in particular a backrest latch for the bolting and unbolting of seat backrests in motor vehicles, with a locking mechanism fundamentally comprising a catch and at least one pawl, whereby the catch is pivotable and is accommodated in the latching device to accommodate a latch holder and whereby the locking mechanism can be transferred at least into a main ratchet position, preferably into a pre-ratchet position and a main ratchet position, by means of the latch holder, a latch housing, whereby the latch housing has at least an integrated recess and whereby the recess is formed as a damping means for the latch holder in the main ratchet position.

Latching devices for automotive applications are used where pivoting or shifting components need to be secured in position. The latching device works together with a latch holder to secure the position of the moving components, whereby a relative movement of the latching device to the latch holder moves the locking mechanism into a locked position.

Areas of application include flaps, doors and sliding doors, but also, for example, backrest bolts for rear seat benches in the motor vehicle passenger compartment. The rear seat bench or backrest can hereby be moved from a fundamentally vertical position into a vertical position by unbolting of the latching device in order, for example, to facilitate boarding or to provide a larger loading area.

The quality of such latching devices is determined by functionality on the one hand and by acoustic behavior on the other hand. Acoustic behavior is a measurable variable for comfort in the motor vehicle. Damping means are used for this purpose which have an impact on the acoustic behavior and are used in particular where interplay occurs between the latch holder and the locking mechanism. The latch holder and the locking mechanism comprising a catch and a pawl are preferably made of metallic materials. In order to damp the interplay and in particular an end stop of the latch holder in interplay with the latching device, different solutions have become known.

From EP 0 894 926 A1 a bolting device has become known for a motor vehicle door latch, whereby the latch housing has a damping means in the base of its accommodation for the latch holder. The damping means has a material recess in the main ratchet position. If the latch holder becomes adjacent in the main ratchet position, the stop becomes deformed without reaching the other side of the material recess. Hard stopping of the latch holder in the latching device is prevented hereby.

A further bolting device for a motor vehicle seat with a catch to bolt a latch holder and a pawl has become known from EP 2 310 227 B1. The pawl locks the catch in the ratchet position. Furthermore, a latch case is provided for which accommodates the catch and the pawl. A latch housing envelops the latch case at least to a great extent, whereby the latch housing has an integrated first stop for the latch holder and whereby the latch holder forms a second stop for the latch holder. The first stop integrated into the latch housing can be formed from material recesses in the latch housing and interacts in an elastic and damping manner with the latch holder.

The previously described solutions with regard to damping means are not convincing in all points. Thus, for example, it is not apparent how the damping means react in relation to the extreme stresses in the motor vehicle. Thus, for example, temperature differences between −40° C. and +80° C. occur in the motor vehicle so that the damping systems which are in particular of a combined design can break down, whereby the acoustic behavior can be negatively impacted. In particular at very high temperatures, the elastic characteristics of plastics can hereby deviate considerably from the characteristics at room temperature. This is where the invention is used.

The object of the invention is to provide an improved latching device for automotive applications, in particular backrest latches. Furthermore, it is a object of the invention to overcome the disadvantages from the state of the art and to provide a damping means which enables safe damping of the latch holder, even in extreme situations. Furthermore, it is a object of the invention to provide a structurally simple and cost-effective option to improve a latching device.

The object is solved by the characteristics of the independent patent claim 1. Advantageous embodiments of the inventions are specified in the sub-claims. It is pointed out that the exemplary embodiments described hereafter are not restrictive; instead, any variations are possible of the characteristics described in the description and the sub-claims.

According to patent claim 1, the object of the invention is solved by a latching device for automotive applications, in particular a backrest latch for the bolting and unbolting of seat backrests in motor vehicles, with a locking mechanism fundamentally comprising a catch and at least one pawl, whereby the catch is pivotable and is accommodated in the latching device to accommodate a latch holder and whereby the locking mechanism can be transferred at least into a main ratchet position, and preferably into a pre-ratchet position and a main ratchet position, by means of the latch holder, a latch housing, whereby the latch housing has at least an integrated recess and whereby the recess is formed as a damping means for the latch holder in the main ratchet position and whereby the integrated damping means has a cooperating section, whereby the cooperating section has a supportive effect on the damping means. By means of the structure of the latching device according to the invention the possibility is now created of safely guaranteeing the damping behavior of the damping means, even in extreme situations, and thus guaranteeing the certainty and constancy of the acoustic behavior of the latching device under all circumstances. By means of the cooperating section in the damping means integrated into the latch housing additional stability can be given to the damping means so that the damping means experiences a brace which supports the recess, for example, at high temperatures and an increased deformation of the latch housing and thus improves the damping behavior in extreme situations.

The latching device has a locking mechanism which comprises a catch and at least one pawl. A pawl is preferably at least arranged in a plane with the catch and is able to lock the catch in a position in interplay with a latch holder. In the case of an opened locking mechanism, an infeed section of the catch points in the direction of the latch holder, whereby a pivoting of the catch occurs by means of a relative movement between the latch holder and the catch. The pawl is generally pre-tensioned by a spring in the direction of the catch so that the pawl engages with the catch when a ratchet position is reached. A pre-ratchet position and a main ratchet position of the locking mechanism can hereby be assumed.

Advantageously, the latching device can have a ratchet or blocking lever in addition to the pawl which maintains the pawl in the locking position. In this case, the locking mechanism consisting of the catch and the pawl has an opening torque at least in the main ratchet position, i.e. the locking mechanism opens independently by means of the force initiated in the locking mechanism, for example from a door seal after pivoting away of the ratchet lever. The blocking or ratchet lever maintains the pawl in its locking position, whereby the pivoting out of the blocking or ratchet lever from the engagement section with the pawl enables independent opening of the locking mechanism. The ratchet or blocking lever is preferably moved out of the engagement section with the pawl by means of the unbolting element or a triggering lever.

The latching device according to the invention can have a manual and/or motorized construction, whereby the unbolting element can be pivoted manually and/or mechanically.

The unbolting element is a component of an unbolting module and forms the latching device together with a basic module. It is conceivable that the unbolting module can be screwed and/or clipped to the basic module. In other words, a detachable and/or non-detachable connection can be produced between the unbolting module and the basic module. The unbolting module comprises at least the pivotably accommodated unbolting element and/or the electrical drive for the unbolting element.

By means of the unbolting element, the pawl and/or the ratchet lever and at least one switching means and/or a damping function can be operated.

The basic module comprises the locking mechanism and, in the case of an insert, a ratchet or blocking lever, the bearing point for the catch, the pawl and the ratchet lever. The catch, pawl and ratchet lever are preferably pre-tensioned with a spring. Due to the assembly of the unbolting module and the basic module, the unbolting element reaches an engagement position or directly engages with the components of the basic module. The unbolting element or the multifunctional element preferably engages with the ratchet lever and reaches an engagement position to operate the pawl.

At least one recess is integrated into the latch housing, whereby the recess has a damping effect so that the latch housing can be deformed in the recess section. If the latch holder goes into the main ratchet position of the locking mechanism, the latch holder thus engages with the latch housing, whereby the latch housing can be deformed.

In one embodiment of the invention, the latch housing has an infeed section for the latch holder, whereby the infeed section has a fundamentally angular, in particular a rectangular-shaped end section. By means of the formation of a rectangular end section, a bridge structure can be attained which can provide an elastically flexible interaction with the latch holder. The latch holder is preferably round or cylindrical so that only a partial adjacency of the latch holder occurs to the latch housing. By means of the construction of a bridge structure in the end section of the latch housing or in the end section of the infeed section of the latch holder in which the latch holder engages with the housing, a selective or only partial adjacency of the latch holder occurs to a bridge structure formed by means of the latch housing. The bridge structure is formed by the rectangular construction of the end section of the accommodation for the latch holder and the recess in the latch housing. By means of the bridge structure a beneficial deformability of the latch housing is guaranteed and the elastic deformability of the latch housing is supported. An engagement ratio between the latch holder and the latch housing which is beneficial for the acoustics can be produced hereby.

A further advantage results if the recess extends crucially parallel to the end section of the infeed section of the latch holder. The bridge structure is completed by a parallel line to the end section, whereby the elasticity of the bridge can be determined on the one hand by the material of the latch housing, the density of the bridge and the length of the recess along the end section. The recess integrated into the latch housing preferably extends in parallel and along the entire end section in the infeed section of the latch holder. A material bridge is attained by the parallel recess in the housing which has two connection points in the latch housing. The material bridge is preferably made of a single component with the latch housing by means of an injection-molding process. The latch housing and the material bridge preferably have a uniform material, but can also have a material beneficial for the damping behavior, for example, by means of a multicomponent injection molding procedure.

If the recess is fundamentally rectangular, a further advantageous configuration variant of the invention thus results. By means of a rectangular formation and in particular a parallel rectangular formation, a symmetrical construction of the material bridge can be attained. The spring characteristic curve course of the material bridge can be set in an advantageously definable manner hereby.

If at least a bulge of the latch housing aligned in the direction of the latch holder extends into the recess, a further configuration variant of the invention thus results. By means of the insertion of a bulge, i.e. a material accumulation into the recess, an additional brace can be provided for the material bridge or the bridge structure in the end section. The at least one bulge, inserted into the recess and preferably into the first recess behind the material bridge in the end section provides a bracing element to prevent excessive deformation of the latch housing. This is advantageous in particular when the latch housing is exposed to extreme stresses. Extreme stresses can occur, for example, if the material is used under extreme weathering conditions. If the latching device is operated at very high temperatures, for example, the spring constant of the material bridge can thus change. In this case, the latch holder would further deform the bridge, whereby the bridge web would become adjacent against the bulge. In this case, the bulge forms a supporting column for the material bridge and thus enables safe dam ping of the latch holder during engagement or interaction with the locking mechanism.

In a further embodiment, the bulge can fundamentally be arranged centrally in the recess. A central arrangement supports the material bridge in the adjacency area of the latch holder. This is especially advantageous as a targeted bracing of the material bridge can hereby be enabled in the maximum stress area. Simultaneously, the force can be initiated into the latch housing and symmetrically by means of the bulge. The regular, i.e. symmetrical, construction of the bulge in the direction of the pitch line of the latch holder thus enables uniform force initiation into the latch housing so that permanent stability can be guaranteed. The latch holder preferably acts centrally on the material bridge if the latch holder interacts with the locking mechanism in the main ratchet position and/or the overstroke position.

If the bulge is fundamentally wavelike, a further configuration variant of the invention thus results. A wavelike formation of the bulge is structurally beneficial as it is easy to produce and simultaneously offers a wave shape and, in particular when the wave shape is formed centrally behind the material bridge, beneficial force initiation ratios into the latch housing. Furthermore, the bracing effect is increased for the material bridge as a broader contact surface is provided for the material bridge in contrast to a tip formation. One, two or three or more wave-shaped bulges can be arranged in the recess. It is thus possible to brace the material bridge not just in one place, but in several places.

However, it is crucial for the invention that the bulge only engages with the bulge after deformation of the end section or the material bridge. The material bridge thus acts as a damper, but can be braced by the bulge in the recess. For example, bracing of the material bridge is necessary if the latch housing is subject to extreme situations, whereby extreme situations occur, for example, by means of high temperatures or large stresses on the latching device. However, the material bridge can provide sufficient damping for the latch holder.

If two or more recesses are formed in the latch housing, a further configuration variation of the invention thus results. The insertion of two or more recesses in the latch housing and in particular a parallel arrangement of the recesses in the direction of the pitch line of the latch holder can have an overall positive effect on the. Three recesses in a row and with fundamentally identical, i.e. rectangular cross-sections are preferably arranged in parallel to the end section of the latch housing. At least the first recess which is directly adjacent to the material bridge which engages with the latch holder preferably has a bulge. Naturally, the other recesses can also have one or several material bulges in the pitch line or outside of the pitch line of the latch holder. According to the stress occurring and the area of application of the latching device and the forces occurring and the damping characteristics required, several bulges can produce a greater bracing effect on the material bridge so that a definable damping coefficient can be attained for the latch holder.

Advantageously, the recesses are fundamentally arranged parallel to one another in the latch housing and/or have a fundamentally identical cross-sectional shape. A symmetrical construction in relation to the arrangement and the cross-sectional shape provides beneficial ratios in the structural configuration of the latch housing. The damping characteristics can hereby be specifically set and calculated in the simulation.

Hereinafter the invention is explained in further detail with reference to the attached drawings on the basis of a preferred embodiment. However, the principle applies that the preferred embodiment does not restrict the invention, but only constitutes an embodiment. The characteristics portrayed can be executed individually or in combination with other characteristics of the description and also the patent claims individually or in combination.

The following are shown:

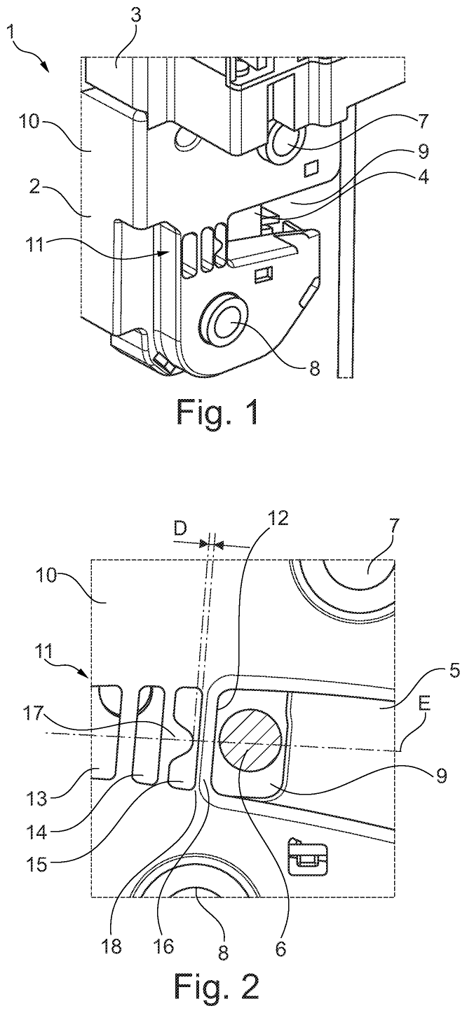

FIG. 1 a three-dimensional view of a backrest latch in the area of the recess of the latch housing and in this embodiment on the basic module of the backrest latch, and

FIG. 2 a detailed view of the backrest latch in the end section of the recess of the latch housing, with recesses illustrated in detail.

A latching device 1 is reproduced in a three-dimensional illustration in FIG. 1. The latching device 1 is a backrest latch for a rear seat backrest of a motor vehicle. The latching device can be attached to the backrest itself or to the chassis and interacts with a non-illustrated latch holder which is arranged on the chassis or the backrest to interact with the latching device 1. The latching device 1 comprises two components in this embodiment and encompasses a basic module 2 and an unbolting module 3. An electrical unbolting device for the latching device is preferably arranged in the unbolting module 3. In turn, the basic module 2 accommodates the locking mechanism 4, whereby the locking mechanism 4 is illustrated in the main ratchet position, i.e. the catch 5 is in the main ratchet position in which the locking bolt 6 is held by the catch 5, whereby the backrest of the motor vehicle can be held in its position, as more clearly apparent from FIG. 2.

Furthermore, the basic module 2 shows two bearing axes 7, 8 for the locking mechanism 4 and a damping means 11 formed according to the invention in the infeed section 9 of the latch holder into the latch housing 10.

The damping means 11 is reproduced in an enlarged view in FIG. 2, whereby FIG. 2 shows the end section 12 of the infeed section 9, the catch 5, the latch holder 6 and the three recesses 13, 14, 15 formed in this embodiment. The latch holder 6 unilaterally engages with the catch 5 and engages on the opposite side with the material bridge 16.

When the latch holder is guided into the infeed section 9 of the latching device 1 the latch holder 6 goes into an overstroke position, i.e. the latch holder 6 is moved into the latching device 1 illustrated in the main ratchet position in FIG. 2 and engages with the material bridge 16. The latch holder 6 is decelerated hereby, having a positive impact on acoustics. If the material bridge 16 is deformed to the extent that the material bridge 16 is deformed into the recess 15, the material bridge 16 thus engages with the wave-shaped bulge 17.

To enable the material bridge 16 to engage with the bulge 17 in the recess 15, the distance D between the material bridge and the bulge 17 must be overcome. After overcoming the distance D, of 0.3 mm for example, the bulge 17 realizes its bracing effect so that safe damping of the latch holder 6 is enabled. As illustrated in the exemplary embodiment according to FIG. 2, the latch holder acts along an infeed line E, whereby an approximately central adjacency of the latch holder 6 to the material bridge 16 can be attained, and whereby simultaneously a central bracing of the material bridge 16 can occur by means of the bulge 17. The further recesses 13, 14 enable the latch housing 10 to elastically deform and permanent stability is guaranteed.

As is clearly apparent in FIG. 2 furthermore, the recesses 13, 14, 15 are arranged parallel to one another and have a fundamentally rectangular shape. The rounded corners of the rectangles advantageously transmit the forces initiated into the latch housing 10 by means of the latch holder in a permanently elastic manner, whereby the connection points 18 enable safe guidance of the lines of force into the latch housing 10.

Due to the construction of the damping means 11 according to the invention a damping means 11 can be provided by means of the latch housing 10 without the necessity for further aids for movement damping of the latch holder. This simplifies the construction of the latching device and provides a cost-effective option for movement damping and acoustic optimization. In particular, the specific formation of bulges in the area of the recesses can provide temperature stability, even in extreme situations.

### REFERENCE SIGN LIST

1 Latching device
2 Basic module
3 Unbolting module
4 Locking mechanism
5 Catch
6 Latch holder
7, 8 Bearing axes
9 Infeed section
10 Latch housing
11 Damping means
12 End section
13, 14, 15 Recesses
16 Material bridge
17 Bulge
18 Connection point
D Distance
E Infeed line

1. A latching device for automotive applications, in particular a backrest latch for the bolting and unbolting of seat backrests in motor vehicles, the latching device comprising:
a locking mechanism including a catch and at least one pawl, wherein the catch is pivotable and is disposed in the latching device to accommodate a latch holder, wherein the locking mechanism can be transferred at least into a main ratchet position, optionally into a pre-ratchet position, and a main ratchet position, by the latch holder,
a latch housing, wherein the latch housing has at least an integrated recess and wherein the recess is formed as a damper for the latch holder in the main ratchet position, and wherein the integrated damper has a cooperating section, whereby the cooperating section has a supportive effect on the damper.

2. The latching device according to claim 1, wherein the latch housing has an infeed section for the latch holder, and that the in-feed section has a fundamentally angular, in particular a rectangular end section.

3. The latching device according to claim 2, wherein the recesses extend fundamentally parallel to the end section of the in-feed section of the latch holder.

4. The latching device according to claim 2, wherein the recess is fundamentally rectangular.

5. The latching device according to claim 2, wherein at least a bulge of the latch housing extends into the recess in the direction of the latch holder.

6. The latching device according to claim 2, wherein the bulge is arranged fundamentally centrally in the recess.

7. The latching device according to claim 6, wherein the bulge is fundamentally wave-shaped.

8. The latching device according to claim 2, wherein two or more recesses are formed in the latch housing.

9. The latching device according to claim 2, wherein the recesses can be arranged fundamentally parallel to one another in the latch housing.

10. The latching device according to claim 2, wherein the recesses have an identical cross-sectional shape.
